(19) United States
(12) Patent Application Publication
(10) Pub. No.: US 2026/0029020 A1
(43) Pub. Date: Jan. 29, 2026

(54) PRECISE-POSITIONING LINEAR ROLLING BEARING AND ELECTROMAGNETIC DRIVE MODULE USING SAME

(71) Applicant: Jiangsu Carya Smart Home Hardware Co. Ltd, Yangzhou (CN)

(72) Inventors: Wei JIANG, Yangzhou (CN); Wei LU, Yangzhou (CN)

(73) Assignee: Jiangsu Carya Smart Home Hardware Co. Ltd, Yangzhou (CN)

(21) Appl. No.: 18/826,230

(22) Filed: Sep. 6, 2024

(30) Foreign Application Priority Data
Jul. 24, 2024 (CN) 2024217623367

(51) Int. Cl. F16C 29/04; H01F 7/08; H01F 7/16

(52) U.S. Cl. CPC F16C 29/04; H01F 7/081; H01F 7/1607; F16C 2380/00; H01F 2007/163

(57) ABSTRACT

A precise-positioning linear rolling bearing is provided. The precise-positioning linear rolling bearing includes a bearing seat, where the bearing seat includes a tube; a plurality of rolling elements for clamping a telescopic mandrel are provided at each of two ends of the tube; a support for supporting the tube is provided on an outer sidewall of the tube; and at least two first positioning pins are provided at a bottom of the support. The precise-positioning linear rolling bearing solves the problem that when the prior art is applied to the electromagnetic drive module, the manufacturing cost is increased.

### CROSS-REFERENCE TO THE RELATED APPLICATIONS

This application is based upon and claims priority to Chinese Patent Application No. 202421762336.7, filed on Jul. 24, 2024, the entire contents of which are incorporated herein by reference.

### TECHNICAL FIELD

The present disclosure relates to the field of household manufacturing, and in particular to a precise-positioning linear rolling bearing and an electromagnetic drive module using the precise-positioning linear rolling bearing.

### BACKGROUND

The Chinese patent with the application No. 2024212755196 provides a linear rolling bearing. The linear rolling bearing includes a tube. Four concyclic first rolling elements are uniformly provided at a left end of the tube. Four concyclic second rolling elements are uniformly provided at a right end of the tube. The first rolling elements and the second rolling elements cooperate to clamp a telescopic mandrel penetrating through the tube. Four positioning grooves are uniformly formed at an outer circumference of the tube. The linear rolling bearing must depend on a base (the positioning grooves each cooperate with a positioning boss on the base to realize precise positioning) in use. This increases the manufacturing cost of the electromagnetic drive module.

### SUMMARY

In view of shortages of the prior art, an objective of the present disclosure is to provide a precise-positioning linear rolling bearing, to lower the manufacturing cost of the electromagnetic drive module.

In order to achieve the above objective, the precise-positioning linear rolling bearing provided by the present disclosure adopts the following technical solutions:

A precise-positioning linear rolling bearing includes a bearing seat, where the bearing seat includes a tube; a plurality of rolling elements for clamping a telescopic mandrel are provided at each of two ends of the tube; a support for supporting the tube is provided on an outer sidewall of the tube; and at least two first positioning pins are provided at a bottom of the support.

Preferably, the support includes two transverse plates integrally formed with the tube; a longitudinal plate is integrally formed between the two transverse plates; the longitudinal plate and the transverse plates enclose a frame; a wing plate extending out of the frame is provided at a bottom of the longitudinal plate; and the first positioning pins are provided at a bottom of the wing plate.

Preferably, a ribbed plate is provided between the wing plate and the longitudinal plate.

Preferably, a plurality of bolt via holes are formed in the wing plate.

Preferably, a vent groove is formed at a bottom of each of the transverse plates; and through the vent groove, an inner cavity of the frame communicates with the outside.

Preferably, reinforcing plates staggered in a grid-shaped manner are provided in the frame.

Preferably, the rolling elements each are a rolling bearing; a boss is integrally formed at the end of the tube; a groove for accommodating the rolling bearing is formed in the boss; and the rolling bearing in the groove is rotatably connected to the boss through a rotating shaft.

Preferably, a rubber ring is sleeved on an outer race of the rolling bearing.

Preferably, for the rolling bearing, end surfaces at two sides of an inner race respectively protrude out of end surfaces at two sides of the outer race.

In order to achieve the above objective, the electromagnetic drive module using the precise-positioning linear rolling bearing provided by the present disclosure adopts the following technical solutions:

An electromagnetic drive module using the precise-positioning linear rolling bearing includes a bottom plate and the telescopic mandrel, where the telescopic mandrel is provided on the bottom plate through the precise-positioning linear rolling bearing; a first positioning hole matching with each of the first positioning pin is formed in the bottom plate; one side of the telescopic mandrel extending out of the precise-positioning linear rolling bearing is provided with a connecting structure; and the other side of the telescopic mandrel extending out of the precise-positioning linear rolling bearing is provided with a drum coil.

Preferably, the connecting structure includes a rod end rolling bearing fixedly connected to the telescopic mandrel; the rod end rolling bearing is hinged to a first transmission rod through a bolt assembly; and the other end of the first transmission rod is hinged to a second transmission rod.

Preferably, the drum coil includes a drum sleeved on the telescopic mandrel; two sides of the drum each are provided with a mounting foot; a second positioning pin is provided at a bottom of the mounting foot; the second positioning pin is configured to precisely position the mounting foot and the bottom plate in assembly; and a conductive wire is wound on the drum.

Compared with the prior art, the present disclosure has the following advantages:
1. The bearing seat is composed of the tube and the support. The first positioning pin is provided at the bottom of the support. The first positioning hole matching with the first positioning pin is formed in the bottom plate, such that a base can be omitted. This can simplify the structure of the electromagnetic drive module, and can reduce the assembly process, thus greatly lowering the manufacturing cost of the electromagnetic drive module.
2. The telescopic mandrel produces noise to some extent when moving on the precise-positioning linear rolling bearing back and forth. The inner cavity of the frame communicates with the outside through the vent groove, such that noise transmitted to the inner cavity of the frame cannot be amplified for resonance.

### BRIEF DESCRIPTION OF THE DRAWINGS

FIG. 1 is a front view of a precise-positioning linear rolling bearing according to the present disclosure;

FIG. 2 is a schematic structural view of a precise-positioning linear rolling bearing according to the present disclosure;

FIG. 3 is a schematic structural view of a bearing seat from a top viewing angle;

FIG. 4 is a schematic structural view of a bearing seat from a bottom viewing angle;

FIG. 5 is a schematic structural view of a rolling bearing;

FIG. 6 is a schematic structural view of an electromagnetic drive module using a precise-positioning linear rolling bearing;

FIG. 7 is a schematic structural view of a connecting structure;

FIG. 8 is a sectional view of a drum coil; and

FIG. 9 is a schematic structural view of a bottom plate.

In the figures: 1: precise-positioning linear rolling bearing, 11: bearing seat, 111: tube, 1111: boss, 1112: groove, 112: support, 1121: transverse plate, 1122: longitudinal plate, 1123: vent groove, 1124: reinforcing plate, 1125: wing plate, 1126: ribbed plate, 1127: bolt via hole, 1128: first positioning pin, 12: rolling element, 121: outer race, 122: rubber ring, 123: inner race, 13: rotating shaft, 2: bottom plate, 21: first positioning hole, 22: second positioning hole, 3: telescopic mandrel, 4: connecting structure, 41: rod end rolling bearing, 42: bolt assembly, 43: first transmission rod, 44: second transmission rod, 5: drum coil, 51: drum, 511: mounting foot, 512: second positioning pin, 52: conductive wire, and 6: swing rod.

### DETAILED DESCRIPTION OF THE EMBODIMENTS

The present disclosure is further described below with reference to the drawing and specific implementations. It should be understood that these implementations are only intended to illustrate the present disclosure, rather than to limit the scope of the present disclosure. Modifications made to the equivalents of the present disclosure by those skilled in the art after reading the present disclosure should fall within the scope defined by the appended claims of the present disclosure.

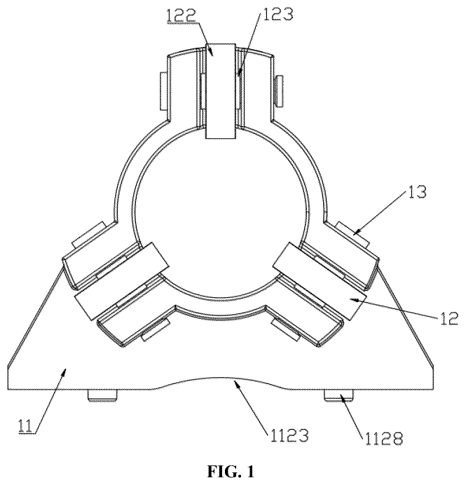

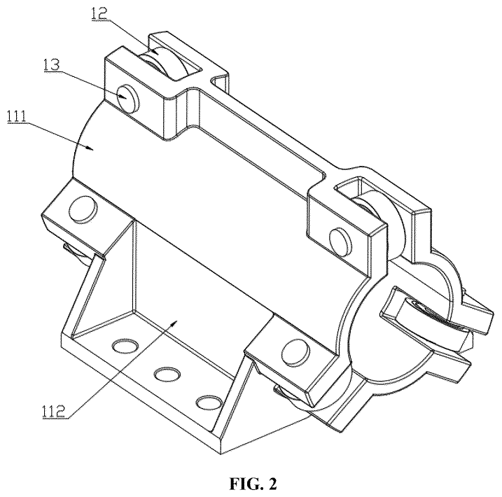

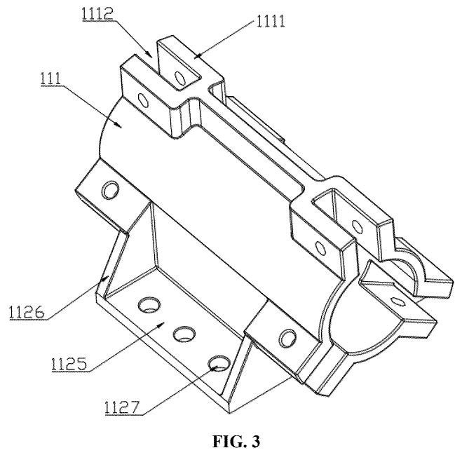

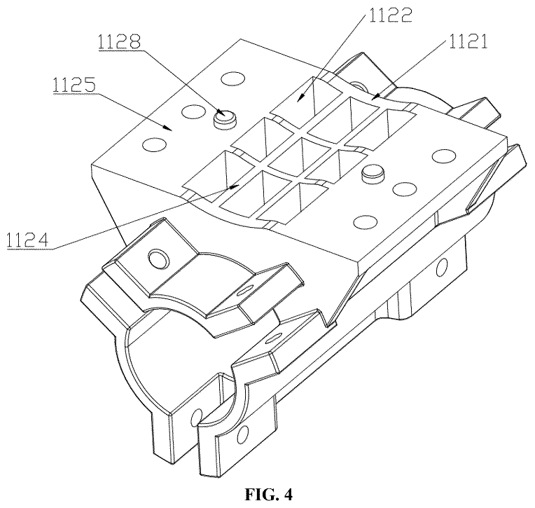

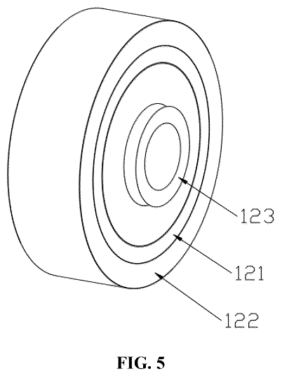

As shown in FIG. 1 to FIG. 5, precise-positioning linear rolling bearing 1 includes bearing seat 11. The bearing seat includes tube 111. Three uniformly distributed bosses 1111 are integrally formed at each of two ends of the tube. Groove 1112 for accommodating rolling element 12 is formed in each of the bosses. The rolling element is a rolling bearing. The rolling bearing is rotatably connected to the boss through rotating shaft 13. Rolling bearings at two sides cooperate to clamp a telescopic mandrel. Rubber ring 122 is sleeved on outer race 121 of the rolling bearing. End surfaces at two sides of the rubber ring are flush with end surfaces at two sides of the outer race. The rubber ring may be made of a polyurethane (PU) material. With the rubber ring, direct contacting friction between the outer race made of a metal material and the telescopic mandrel made of a metal material is prevented, thereby reducing noise and achieving a mute effect. For the rolling bearing, end surfaces at two sides of inner race 123 respectively protrude out of the end surfaces at the two sides of the outer race. This prevents friction of the outer race and the rubber ring with sidewalls of the grooves at the two sides to cause mutual wear and noise. Support 112 for supporting the tube is integrally formed at a middle of an outer sidewall of the tube. The support includes two transverse plates 1121 integrally formed with the tube. Longitudinal plate 1122 is integrally formed between the two transverse plates. The longitudinal plate and the transverse plates enclose a frame. Vent groove 1123 is formed at a bottom of each of the transverse plates. Through the vent groove, an inner cavity of the frame communicates with the outside. The telescopic mandrel produces noise to some extent when moving on the precise-positioning linear rolling bearing back and forth. The inner cavity of the frame communicates with the outside through the vent groove, such that noise transmitted to the inner cavity of the frame cannot be amplified for resonance. Reinforcing plates 1124 staggered in a grid-shaped manner are integrally formed in the frame, so as to improve a strength of the frame. Wing plate 1125 extending out of the frame is integrally formed at a bottom of the longitudinal plate. Ribbed plate 1126 is integrally formed between each of two ends of the wing plate and the longitudinal plate, so as to improve a strength of the wing plate. Three bolt via holes 1127 arranged along a length direction of the tube are formed in the wing plate. First positioning pin 1128 is integrally formed at a bottom of the wing plate.

The precise-positioning linear rolling bearing provided by the present disclosure has the following working process and principle: The bearing seat realizes precise-positioning assembly with a bottom plate through the first positioning pin, such that a base can be omitted. This can simplify the structure of the electromagnetic drive module, and can reduce the assembly process, thus greatly lowering the manufacturing cost of the electromagnetic drive module.

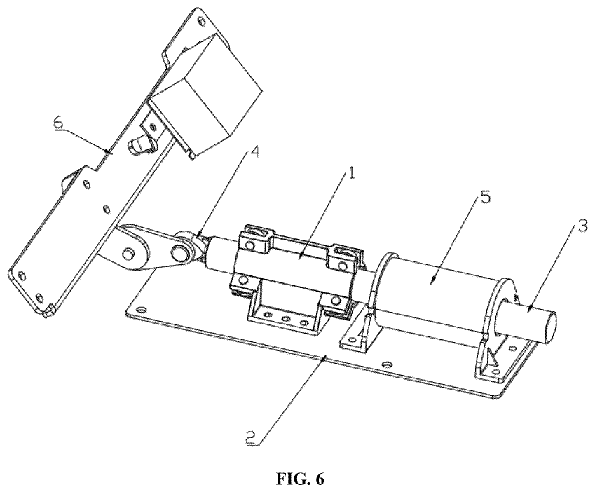

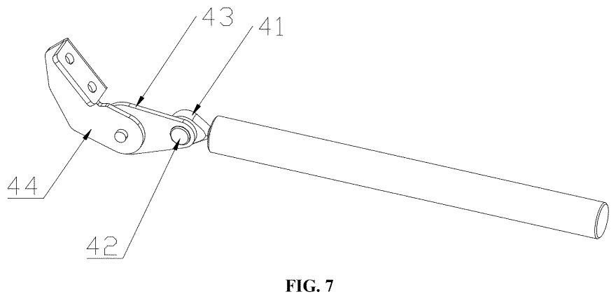

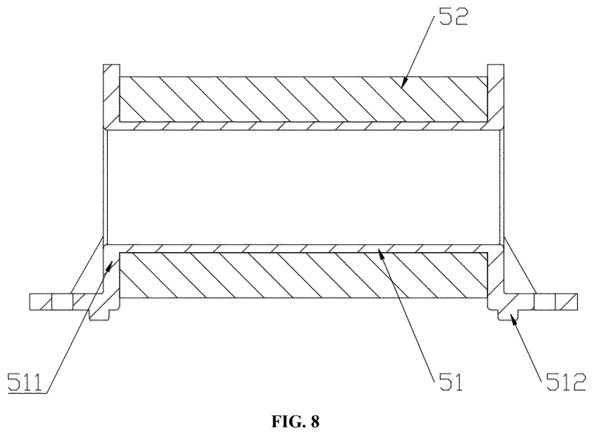

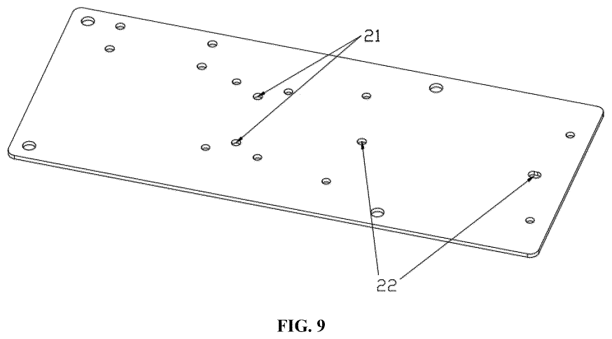

As shown in FIG. 6 to FIG. 9, an electromagnetic drive module using the precise-positioning linear rolling bearing includes bottom plate 2 and the telescopic mandrel 3. The telescopic mandrel is provided on the bottom plate through the precise-positioning linear rolling bearing 1. First positioning hole 21 matching with the first positioning pin is formed in the bottom plate. A left side of the telescopic mandrel extending out of the precise-positioning linear rolling bearing is provided with connecting structure 4. The connecting structure includes rod end rolling bearing 41 fixedly connected to the telescopic mandrel. The rod end rolling bearing is hinged to first transmission rod 43 through bolt assembly 42. The other end of the first transmission rod is hinged to second transmission rod 44. A right side of the telescopic mandrel extending out of the precise-positioning linear rolling bearing is provided with drum coil 5. The drum coil includes drum 51 sleeved on the telescopic mandrel. Mounting foot 511 is integrally formed at each of two sides of the drum. Second positioning pin 512 is integrally formed at a bottom of the mounting foot. Second positioning hole 22 matching with the second locating pin is formed in the bottom plate. Conductive wire 52 is wound on the drum. For ease of assembly, either of two second positioning holes may be a waist-shaped hole, and either of two first positioning holes may also be a waist-shaped hole.

The electromagnetic drive module using the precise-positioning linear rolling bearing has the following specific working process and principle: When the drum coil is powered on, a magnetic field is generated to attract the telescopic mandrel to move rightward. The telescopic mandrel drives swing rod 6 through the connecting mechanism (the swing rod is configured to drive a rocker to swing back and forth). The swing rod swings to a right upper side. By this time, the drum coil is powered off, the magnetic field disappears, there is no attractive force for the telescopic mandrel, and the swing rod falls back and swings to a left upper side for a gravity. Meanwhile, through the connecting mechanism, the telescopic rod is driven to move leftward. When the swing rod falls back from the left upper side, the drum coil may be powered on again to provide the attractive force for the telescopic mandrel. In this case, the swing rod is stressed by an inertia force and the electromagnetic attractive force to obtain a larger amplitude. By repeating this process cyclically, the amplitude of the swing rod can be stabilized at a value. When the swing rod needs to stop, the drum coil is powered on when the swing rod swings to the left upper side, such that the attractive force on the telescopic mandrel is taken as a resistance to prevent the swing rod from swinging to the left upper side. In this way, the amplitude of the swing rod is gradually reduced, until the swing rod stops at a middle position.

What is claimed is:

1. A precise-positioning linear rolling bearing, comprising a bearing seat, wherein the bearing seat comprises a tube; a plurality of rolling elements for clamping a telescopic mandrel are provided at each of two ends of the tube; a support for supporting the tube is provided on an outer sidewall of the tube; and at least two first positioning pins are provided at a bottom of the support.

2. The precise-positioning linear rolling bearing according to claim 1, wherein the support comprises two transverse plates integrally formed with the tube; a longitudinal plate is integrally formed between the two transverse plates; the longitudinal plate and the two transverse plates enclose a frame; a wing plate extending out of the frame is provided at a bottom of the longitudinal plate; and the at least two first positioning pins are provided at a bottom of the wing plate.

3. The precise-positioning linear rolling bearing according to claim 2, wherein a vent groove is formed at a bottom of each of the two transverse plates; and through the vent groove, an inner cavity of the frame communicates with outside.

4. The precise-positioning linear rolling bearing according to claim 3, wherein reinforcing plates staggered in a grid-shaped manner are provided in the frame.

5. The precise-positioning linear rolling bearing according to claim 1, wherein each of the plurality of rolling elements is a rolling bearing; a boss is integrally formed at the end of the tube; a groove for accommodating the rolling bearing is formed in the boss; and the rolling bearing in the groove is rotatably connected to the boss through a rotating shaft.

6. The precise-positioning linear rolling bearing according to claim 5, wherein a rubber ring is sleeved on an outer race of the rolling bearing.

7. The precise-positioning linear rolling bearing according to claim 6, wherein for the rolling bearing, end surfaces at two sides of an inner race respectively protrude out of end surfaces at two sides of the outer race.

8. An electromagnetic drive module using the precise-positioning linear rolling bearing according to claim 1, comprising a bottom plate and the telescopic mandrel, wherein the telescopic mandrel is provided on the bottom plate through the precise-positioning linear rolling bearing; a first positioning hole matching with each of the at least two first positioning pins is formed in the bottom plate; a first side of the telescopic mandrel extending out of the precise-positioning linear rolling bearing is provided with a connecting structure; and a second side of the telescopic mandrel extending out of the precise-positioning linear rolling bearing is provided with a drum coil.

9. The electromagnetic drive module according to claim 8, wherein the connecting structure comprises a rod end rolling bearing fixedly connected to the telescopic mandrel; the rod end rolling bearing is hinged to a first end of a first transmission rod through a bolt assembly; and a second end of the first transmission rod is hinged to a second transmission rod.

10. The electromagnetic drive module according to claim 8, wherein the drum coil comprises a drum sleeved on the telescopic mandrel; two sides of the drum each are provided with a mounting foot; a second positioning pin is provided at a bottom of the mounting foot; the second positioning pin is configured to precisely position the mounting foot and the bottom plate in assembly; and a conductive wire is wound on the drum.

11. The electromagnetic drive module according to claim 8, wherein in the precise-positioning linear rolling bearing, the support comprises two transverse plates integrally formed with the tube; a longitudinal plate is integrally formed between the two transverse plates; the longitudinal plate and the two transverse plates enclose a frame; a wing plate extending out of the frame is provided at a bottom of the longitudinal plate; and the at least two first positioning pins are provided at a bottom of the wing plate.

12. The electromagnetic drive module according to claim 11, wherein in the precise-positioning linear rolling bearing, a vent groove is formed at a bottom of each of the two transverse plates; and through the vent groove, an inner cavity of the frame communicates with outside.

13. The electromagnetic drive module according to claim 12, wherein in the precise-positioning linear rolling bearing, reinforcing plates staggered in a grid-shaped manner are provided in the frame.

14. The electromagnetic drive module according to claim 8, wherein in the precise-positioning linear rolling bearing, each of the plurality of rolling elements is a rolling bearing; a boss is integrally formed at the end of the tube; a groove for accommodating the rolling bearing is formed in the boss; and the rolling bearing in the groove is rotatably connected to the boss through a rotating shaft.

15. The electromagnetic drive module according to claim 14, wherein in the precise-positioning linear rolling bearing, a rubber ring is sleeved on an outer race of the rolling bearing.

16. The electromagnetic drive module according to claim 15, wherein in the precise-positioning linear rolling bearing, for the rolling bearing, end surfaces at two sides of an inner race respectively protrude out of end surfaces at two sides of the outer race.
